(19) United States
(12) Patent Application Publication
(10) Pub. No.: US 2008/0058996 A1
(43) Pub. Date: Mar. 6, 2008

(54) UPS monitoring and controlling software embedded into a DSP-based online UPS equipment

(75) Inventors: Kunwer Sachdev, New Delhi (IN); Narender Negi, New Delhi (IN); Sashi Kumar, New Delhi (IN); Ajay Lakhanpal, New Delhi (IN); Devender Singh, New Delhi (IN)

Correspondence Address: VENABLE LLP, P.O. BOX 34385, WASHINGTON, DC, 20043-9998, US

(73) Assignee: Sukam Power Systems Limited, New Delhi (IN)

(21) Appl. No.: 11/892,526

(22) Filed: Aug. 23, 2007

(30) Foreign Application Priority Data
Aug. 25, 2006 (IN) 1917/DEL/2006

(51) Int. Cl. H02J 3/14

(52) U.S. Cl. 700/291

(57) ABSTRACT

The present invention relates to a unique and novel PC based software solution interface with embedded DSP based Online UPS system. In the present invention, a single DSP is used to control the Online UPS and further to communicate with the PC based software which enables direct transfer of real-time values of parameters to the PC. Such direct transfer of data is accomplished through a dedicated communication protocol that is implemented both inside the DSP chip, and in the monitoring software. As the DSP can process the information very fast, the processing of all the data can be completed by the DSP and transferred to the monitoring software. The requisite provisions are made in the DSP embedded chip inside the Online UPS system so as to receive the data from the Monitoring system and correspondingly change the Output voltage/Frequency, Battery Low level and battery high level.

### FIELD OF THE INVENTION

The present invention relates to a UPS monitoring and controlling software embedded in Online UPS Systems, adaptable to a Digital Signal Processor technology (DSP) which ensures high consistency in the UPS Systems. It is known that DSP technology provides faster and precise controls of UPS System to provide effective and safe mechanisms to protect end user's important data and hardware.

More particularly, the present invention relates to a unique and novel PC based software solution interface with embedded DSP based Online UPS system.

### BACKGROUND OF THE INVENTION

Uninterruptible Power Systems (UPS) are critical in saving and protecting valuable computer data. A typical online UPS equipment is expected to provide a high degree of power conditioning, power regulation and in the case of power failure, provide the requisite power back-up needed for a proper shut down of a computer processes and files. Since the Online UPS are the source of power to the computers, it is necessary to provide features to save files automatically before UPS shuts down, schedule the shutdown times and perform the power audit of incoming power including power generated by the UPS. Further, the Online UPS operating critical equipments must be provided with means to monitor the performance of the UPS systems from remote location, which will greatly minimize the MTTR (Mean Time to Reconnect).

The Data centers are generally equipped with a variety of storage devices, monitors, servers, communications devices and several other related equipment. Synchronization and optimization of the UPS technologies, in particular for systems catering features, functionalities and plurality of devices as described hereinabove, a further improvement of the UPS-technologies is an immediate need of the art.

Typically, a DSP controller manages several functions including:
Sensing and controlling input and output voltage and current levels,
Setting and controlling the DC voltage in the inverter,
Setting and controlling the inverter for output voltage and frequency regulation,
Controlling the battery charger,
Interfacing with power management software through communication port, and
Switching to an electronic bypass.

DSPX was originally designed for mathematically extensive motor drive control processes. However, the DSP is now incorporated with new capabilities such as faster machine-cycle speeds and enhanced programming instruction sets. It also offers peripheral functionality such as onboard counters and timers, analog-to-digital converters, pulse-width-modulation outputs, flash memory, and controller-area network communications. The similarities between the motor drive controls and the UPS controls, combined with an enhanced functionality the next generation DSP, the UPS becomes a “natural” application for the DSP.

Low-cost, high-performance DSP controllers provide an improved and cost-effective solution for the UPS design. Signal Processors allow the UPS designers to replace bulky transformers, relays and mechanical bypass switches with smaller, more intelligent functional equivalents. DSP implementations further facilitate other associated design benefits, including increased power efficiency and increased power density—smaller product footprint with less weight—a necessity in space—constrained data centers.

In UPS applications, the DSP has integrated certain functions selected for sophisticated embedded controls. These functions, previously available through more expensive microcontrollers and off-board peripheral circuitry, include protection circuitry, clocks and serial communications, in addition to the peripheral DSP functionality described hereinabove. Except for signal conditioning and actuators that provide the interface between the DSP and the power circuitry, all the control implementations become digital. Multiple control algorithms can execute almost simultaneously and at high Machine-cycle speeds such a dynamic performance. The DSP implementation comprises fewer parts, increase reliability and greater immunity to noise than the prior art microcontroller implementations. Since the DSP feedback and control loops are implemented digitally, compensation for component tolerances and temperature and variations of feedback elements is no longer necessary. DSP technology provides a cost-effective alternative for controlling multiple power controllers, either individually or in combination, to meet the demands of advanced power topologies.

Some of the existing online UPS do not have the monitoring and control software interface at all. The biggest problem faced on using such Online UPS is that when the Battery goes low it shuts down the system connected to it abruptly. This results in loss of data and also results in System failure.

The other existing Online UPS although may have software for monitoring Online UPS system, they however entail various drawbacks in implementation of the software control such as:
1. The monitoring and control software interface, are not in real time. They do not provide the instantaneous values of input voltage/Frequency, Output voltage/Frequency, Load connected to the UPS system. They cannot do the power audit nor they enable the systems to be remotely monitored. Further, such UPS does not allow a change of the UPS output voltage/Frequency. They are unable to log the UPS data with data and time stamp. Additionally, under defined conditions or as per schedule, the system is unable to send SMS/Email to the Users. A plurality of User interventions are often required in using such software which is not capable of self analysis of data.
2. Remote monitoring and control of the Online UPS is not available in most the prior art systems. However, in the limited versions where such feature is available, an additional card has to be connected to the UPS system, which increases the hardware including the cost of the system.

### OBJECTS OF THE INVENTION

It is therefore an object of the invention to provide a novel software for monitoring and controlling Online USP System based on DSP technology which eliminates the drawbacks of the prior art.

### SUMMARY OF THE INVENTION

In the present invention, a single DSP is used to control the Online UPS and further to communicate with the PC based software which enables direct transfer of real-time values of parameters to the PC. Such direct transfer of data is accomplished through a dedicated communication protocol that is implemented both inside the DSP chip, and in the monitoring software. As the DSP can process the information very fast, the processing of all the data can be completed by the DSP and transferred to the monitoring software. The requisite provisions are made in the DSP embedded chip inside the Online UPS system so as to receive the data from the Monitoring system and correspondingly change the Output voltage/Frequency, Battery Low level and battery high level.

The present invention enables remote monitoring and control of any DSP based online UPS using web based application, and without adding any additional hardware. Various Monitoring and Control Software's running on different servers connected to a dedicated Server from where the data can be transmitted to a web page.

The present invention provides real time monitoring of the UPS Parameters in digital including graphical form for example, Input and Output Voltage, Input and Output Frequency, Battery Voltage, Load, Output Current, output power and UPS Capacity.

The present invention further provides logging of various Parameters at specified intervals, for example 10 sec . . . 60 sec.

The present invention also provides a method which is highly secured in which a unique login and password is incorporated.

The present invention enables sending an e-mail to single/multiple user on different conditions including sending SMS to single/multiple user on different conditions such as “Battery Voltage Low, Battery Voltage High, Output Over Voltage and Output Under Voltage.

The present invention is capable of generating SMS UPS Parameters regularly at some specified interval (1 hrs, 2 hrs and 3 hrs).

The present invention provides “Auto and Manual” saving of Graphics including Auto saving of files in order to protect the running files.

The present invention has several other features as enumerated hereinbelow:—
1. Provides the end users with the flexibility, to toggle off between ‘Server and UPS Shutdown’.
2. UPS Scheduling as per user requirements.
3. auto-saving of UPS Parameters in File. User can view the status of UPS Parameters (I/P and O/P Voltage, I/P or O/P frequency and O/P Power) by plotting from the file.
4. Printing of Graph, Logged data.
5. Saving of Log Data in File.
6. Shutdown of Clients on network.
7. Broadcast of various notification messages (like Battery Voltage High, Battery Voltage Low, Overload messages).
8. Alert warnings through sound.
9. Provision for the end user to change UPS settings (Change the settings of UPS output voltage, battery voltage low and battery voltage high.
10. Provision for the administrator to change the priority settings.
11. Provision for the Administrator to change the Server and UPS Shutdown Settings.

### BRIEF DESCRIPTION OF THE ACCOMPANYING DRAWINGS

FIG. 1.10 shows a user registration before running the software

FIG. 1.11 shows selection of a commport of the server system by the user.

FIG. 1.12 shows the main panel display information on various status.

FIG. 1.13 shows the user's access to the setting.

FIG. 1.13a shows the configuration of the software by the user for several tasks.

FIG. 1.14 shows the setting of the software under SMS.

FIG. 1.15 shows the status of UPS parameters facilitating use of SMS.

FIG. 1.16 shows the UPS setting by the user.

FIG. 1.17 shows the configuration of the software to broadcast the notification message.

FIG. 1.18 shows updating of the user's personal information.

FIG. 1.19 shows a scheduler to shut down all particular segments of the UPS load.

FIG. 1.20 shows viewing of data logged by the user at any time.

FIG. 1.21 shows the features for viewing graphs. -1.25

FIG. 1.25a shows the user's enablement to see and analyse the status of UPS parameters during ‘off-time’.

FIG. 2.10 shows user registration of client software.

FIG. 2.11 shows updating of server IP.

FIG. 2.12 shows updating of the priority by the user.

FIG. 2.13 shows updating of the user's name and password.

### DETAILED DESCRIPTION OF A PREFERRED EMBODIMENT OF THE INVENTION

Intelli-Q DSP ONLINE UPS monitoring and controlling software interacts with the DSP ONLINE UPS via serial port and exchanges the data between the PC and the UPS. A special protocol to exchange the data between the server and the UPS has been developed.

The software displays the real-time status of UPS (for example input and output voltage, input and output frequency, load on UPS capacity, output current, output power, battery capacity etc.) in digital and graphical form which helps the user to monitor the quality of power supply. Simultaneously, the User can remotely monitor UPS via network and manage the UPS more effectively. On AC failure or UPS battery low, it will perform its monitoring and shutdown functions, even without people around. The software can also send the warning messages via SMS and E-mail.

Salient Features
Real-time software interacts with DSP to exchange data.
Support multiple PC shut down.
Sends warning message by e-mail automatically.
Sends SMS for the warning message automatically.
Detects AC fail and UPS battery low automatically.
Runs Time Scheduler to turn on/off your PC's.
Broadcasts warning message on all PC's connected.
Sets the countdown timing and the interval of each warning.
Before System shutdown, automatically saves file on PC.
Records and analyzes the critical UPS parameters.

Software Overview

The software is comprised of two components: server application software and client application software.

Server Application Software
Performs communication with UPS.
Performs shutdown of local server.
Communicates with Client PC's to initiate shutdowns of the machines.
Provides SMS, email and broadcast notifications based on UPS events.

Clients Application Software
Communication with the server.
Receives UPS parameters from server software and displays to the user.
Pops up messages in case of battery low or scheduled shutdown.

Supported Operating Systems

The operating systems supported by the Server application are:
Windows 98
Windows ME
Windows NT
Windows 2000
Windows XP
Linux

Hardware Installation

The following steps are required to install hardware:
Connecting the male connector of cable to UPS communication port.
Connecting the female connector of cable to RS-232 communication port of system.

User Registration

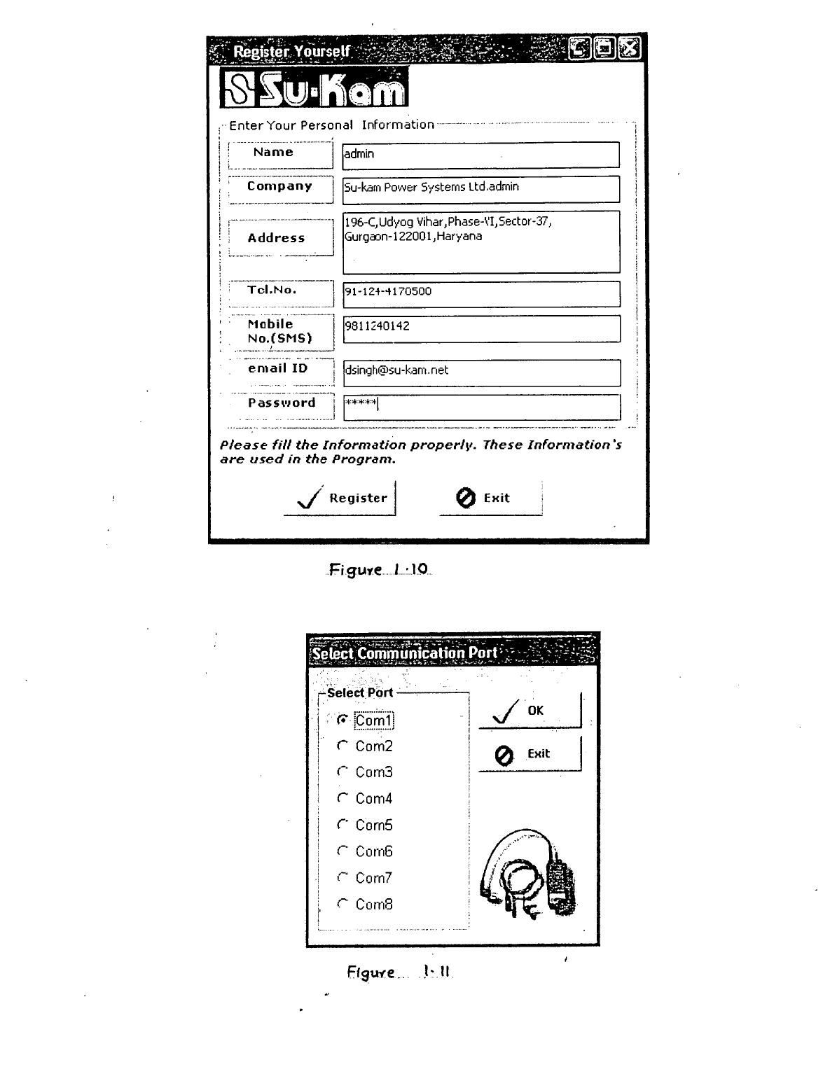

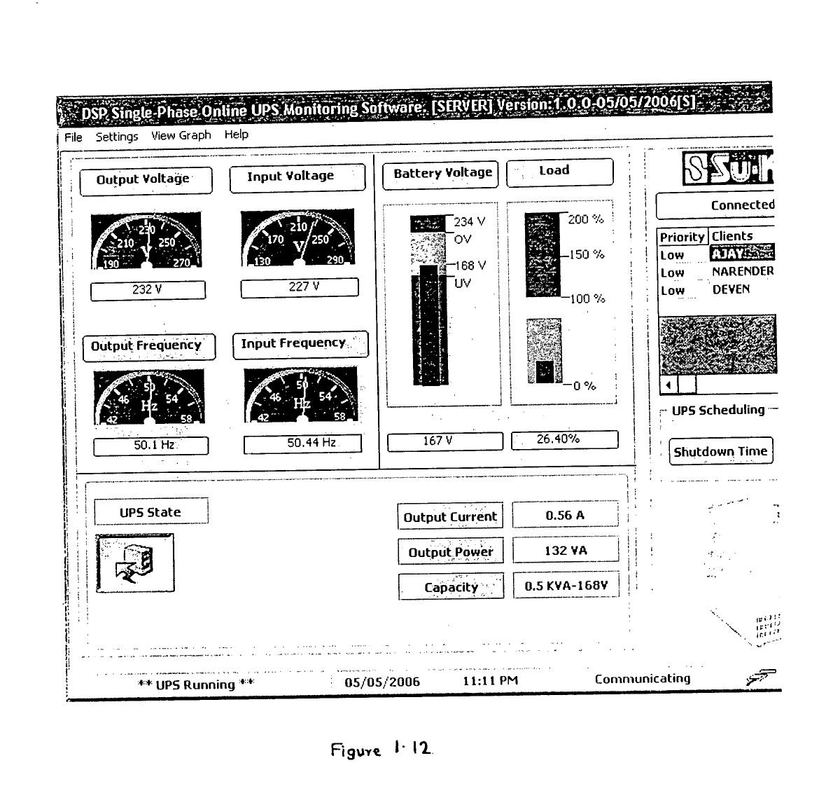

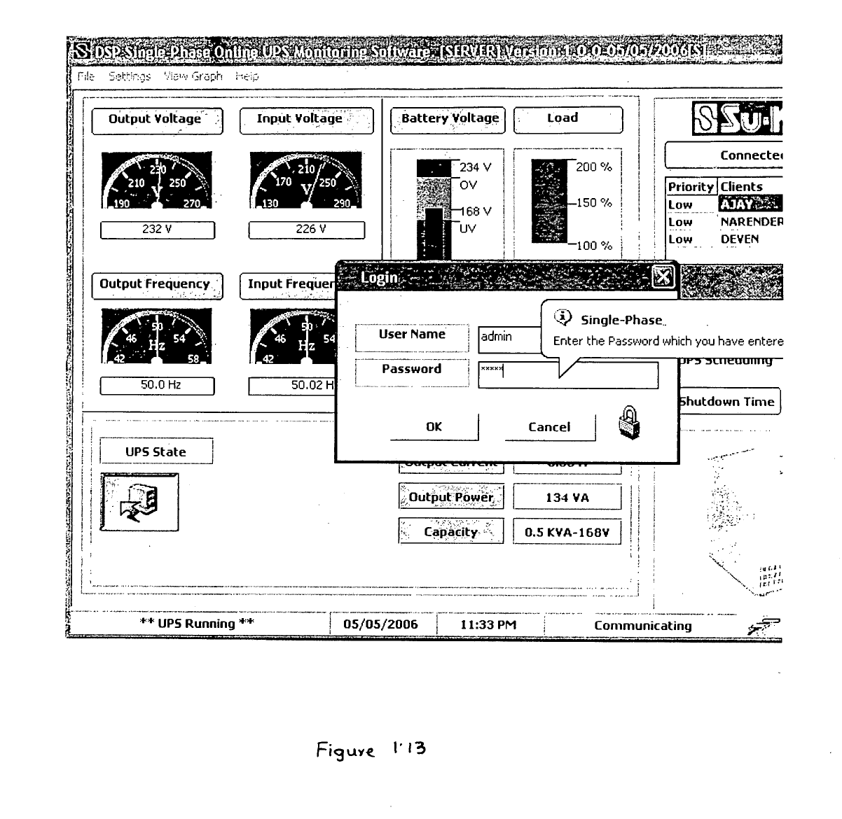

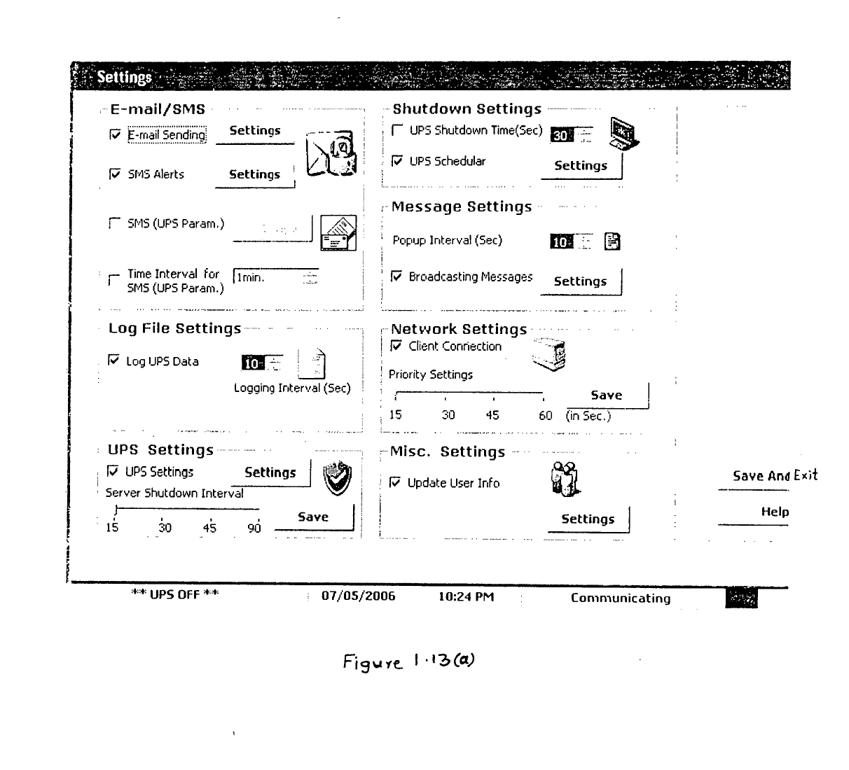

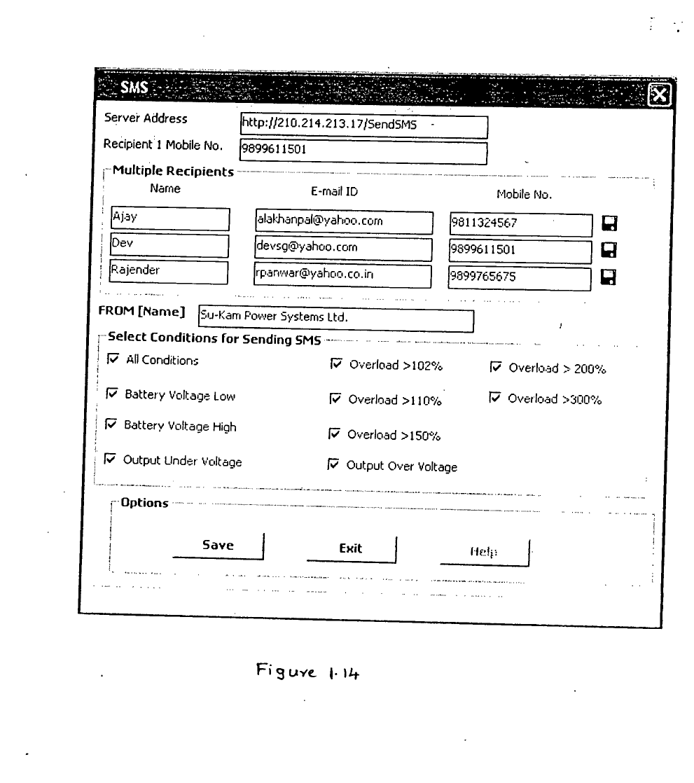

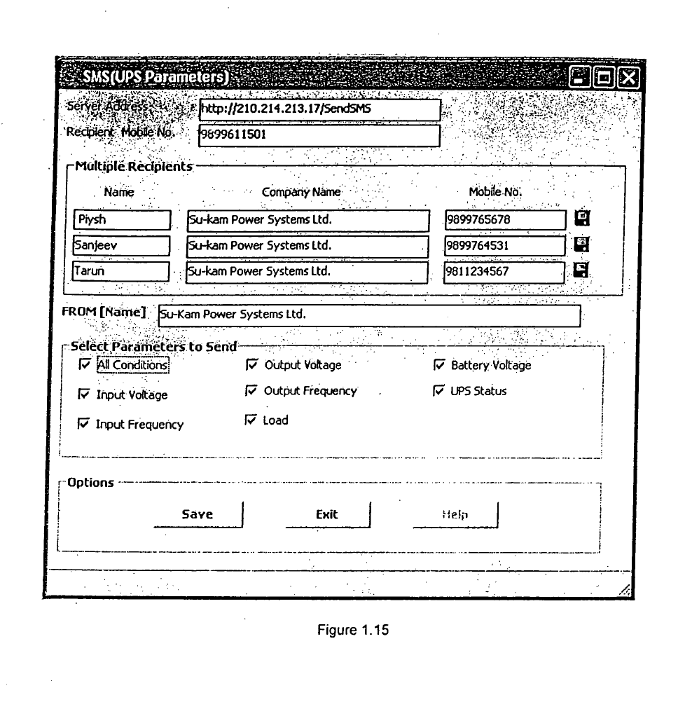

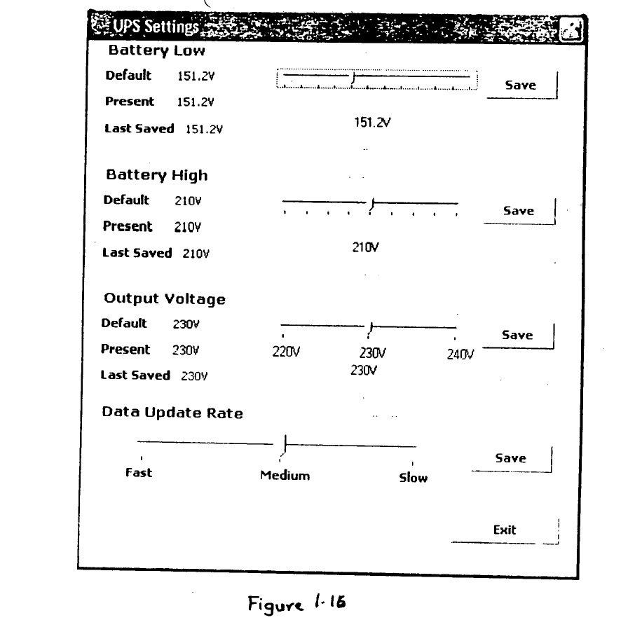

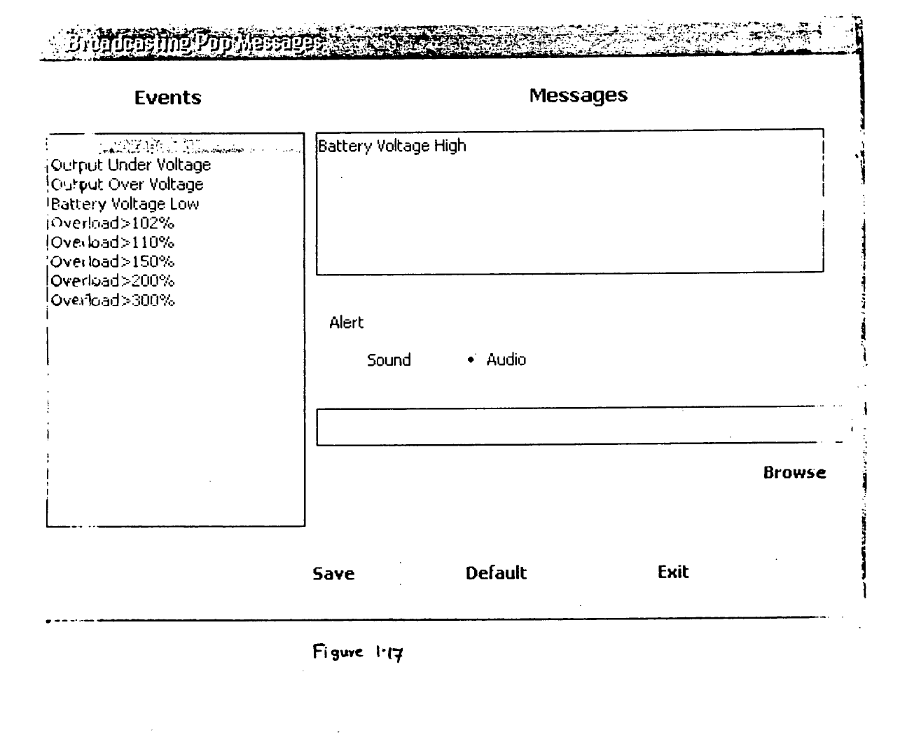

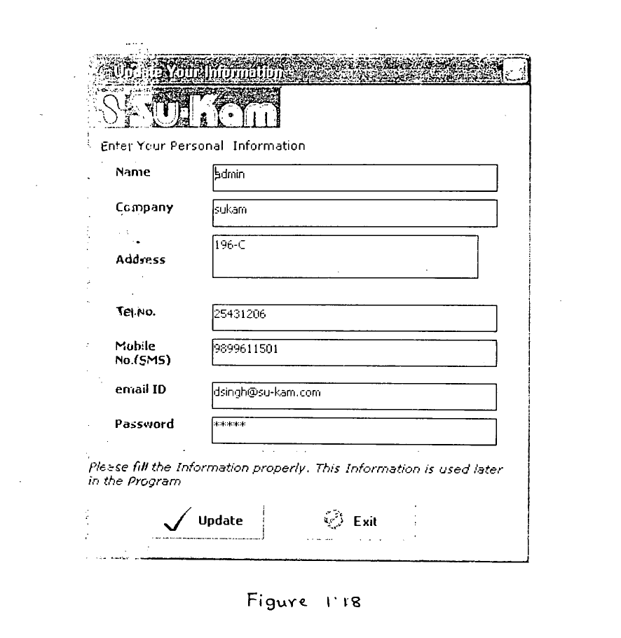

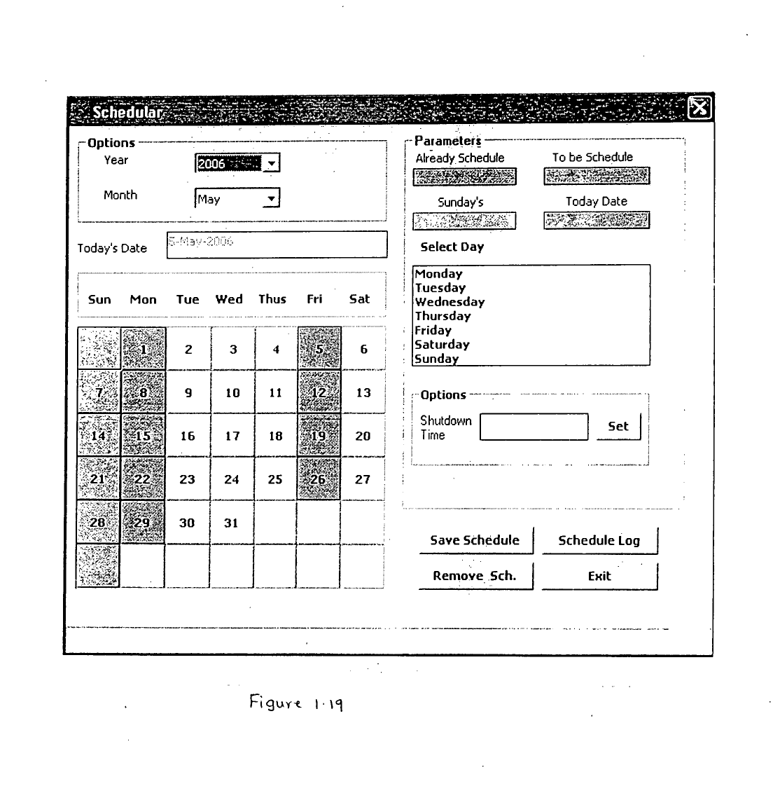

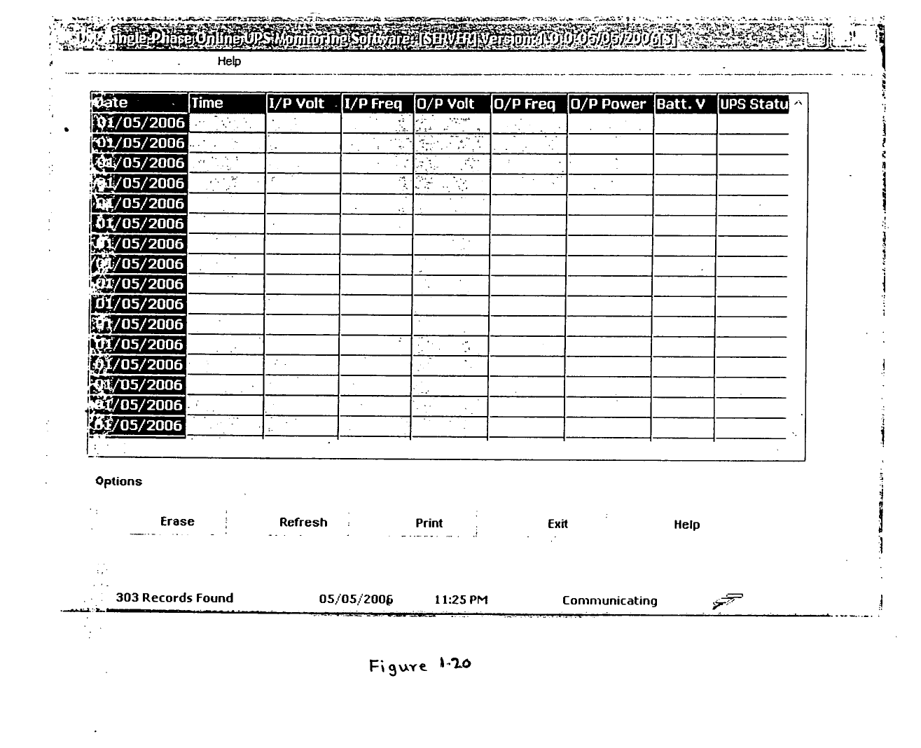

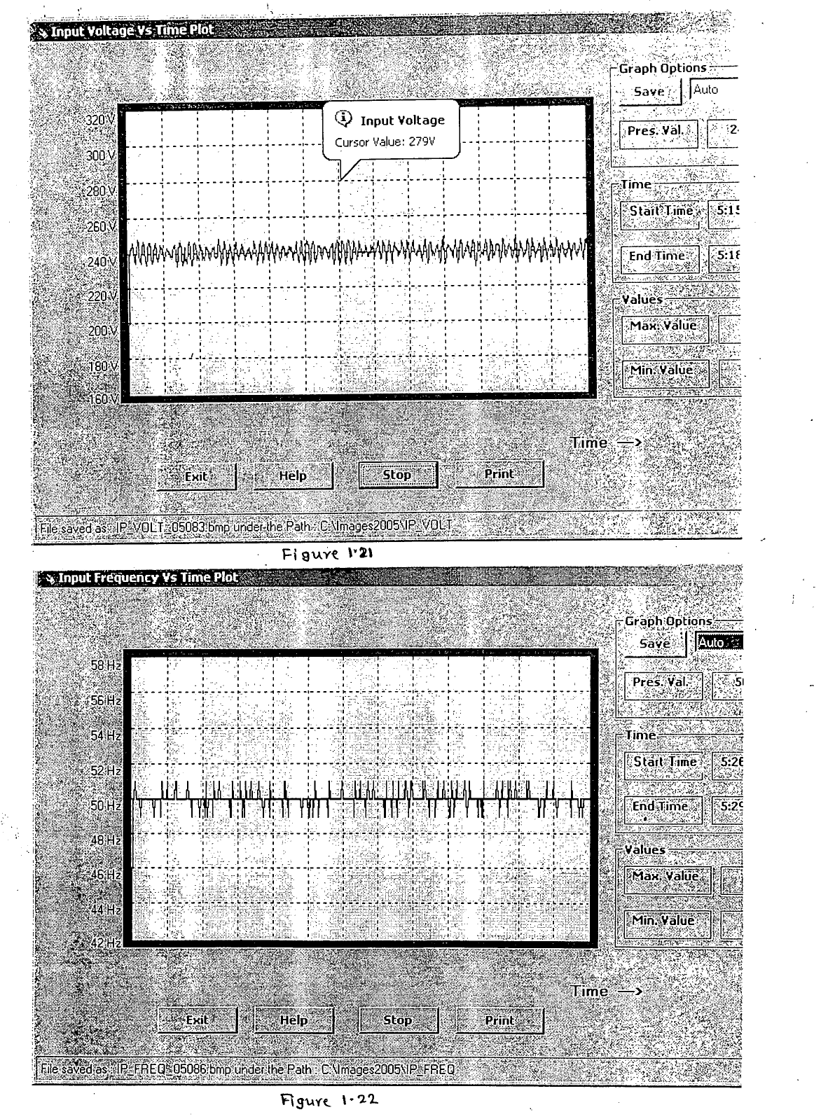

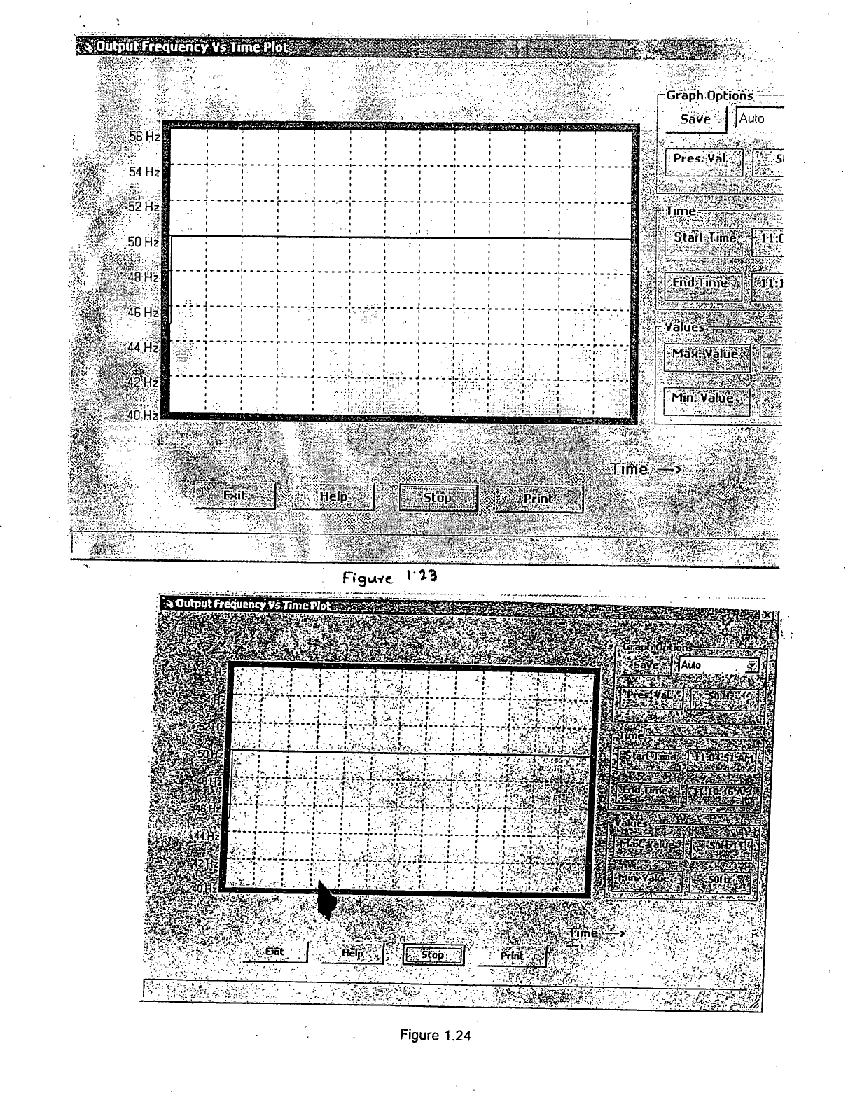

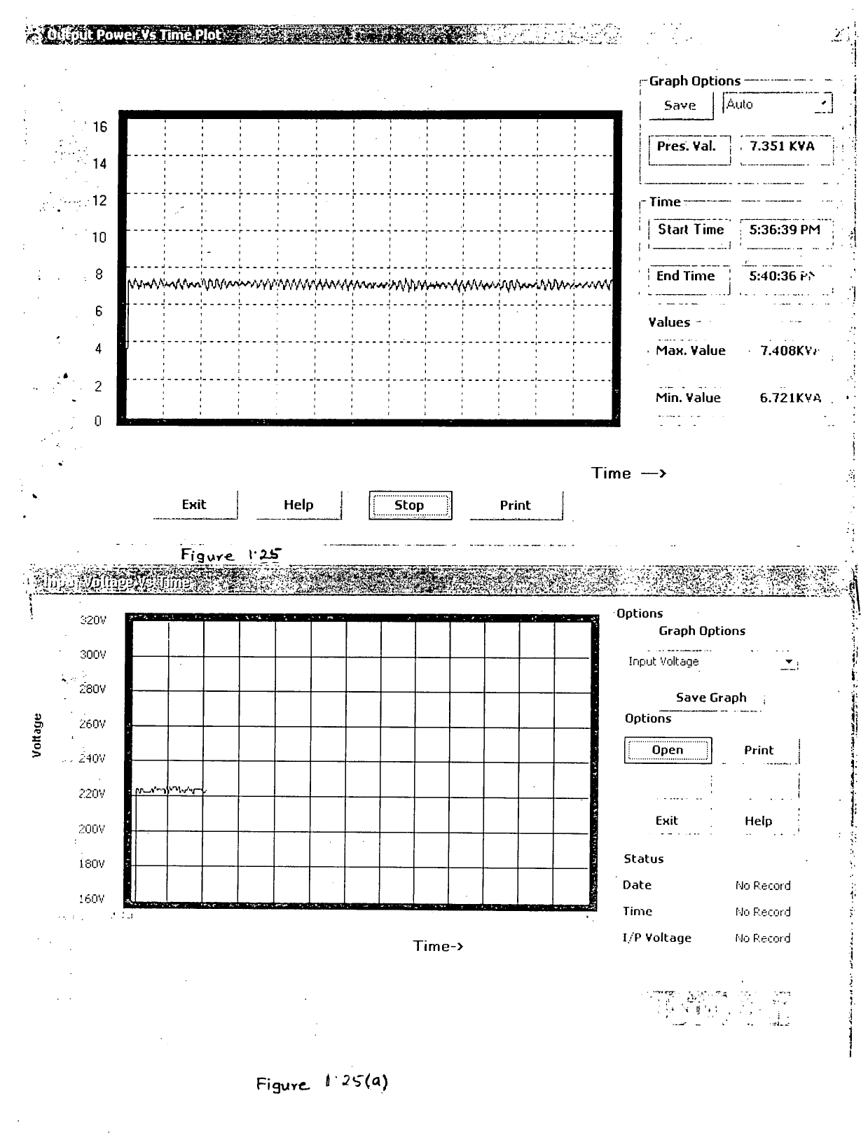

As shown in FIG. 1.10, a user has to register first before running the software for the first time. A user account is set up. Logging in under this account allows the user to completely configure the software. The requisite information should be filled and no information should be left blank.

Select a Commport

It is necessary for the user to select (FIG. 1.11) the Commport of Server system to which RS-232 connector from UPS is connected. The software uses this port to communicate with the UPS. The user don't have to select the commport every time. Once the user selects the commport, it would be automatically selected, every time. If somehow the user has connected RS-232 connector Rs-232 connector to some other port then the user has to reselect that port and, then, that port would be automatically selected.

Select Port

From the selected port, the communications port is to be selected, to which the UPS is attached.

Choose OK to save changes and close the communications port setup dialog box.

Choose cancel to close the communications port setup dialog box without saving it.

Interpreting the Main Panel

As illustrated in FIG. 1.12, the main panel displays information on the status of the grid power, UPS Power, battery status, UPS On/Off, number of clients connected and Communications status.

The main panel is a graphical representation of the operational status of the system. Input and output voltage, input and output frequency is shown with the help of Analog meters. Battery voltage and load connected to the UPS are indicated with the help of Bar Graphs. It also displays output current, output power and UPS capacity.

The display automatically detects the configuration of the UPS and adjusts itself accordingly. The Console is the interface with the UPS. It provides detailed information regarding user's present power situation and the controls for such features as orderly system shutdown and configuration alerts.

| | |
|---|---|
| Output Voltage: | The voltage generated by the UPS |
| Output Frequency: | The frequency generated by the UPS |
| Input Voltage: | The grid voltage fed to the UPS |
| Input Frequency: | The frequency of grid voltage fed to the UPS |
| Battery Voltage: | The voltage of the battery bank connected to the |
| | UPS |
| Load: | The load connected to the UPS. Load bar graph in |
| | red zone is a cause for concern. A node shutdown |
| | will occur. Users to save his work and close his |
| | files immediately, then try to analyze and resolve |
| | the problem. If load bar graph in the green range, |
| | the user is operating safely within the range of |
| | the UPS. |

Secure Access: The software provides secure access for the user to make changes in the software user who has a valid account can only make changes in the Settings. The software provides secure way to make changes. As shown in FIG. 1.13, the user has to enter his valid user name and password in order to access the settings.

Settings

The setting menu allows the user to configure the software as per the requirements. The following settings for the DSP Online UPS can be done:
1. E-mail and SMS settings
2. Data log file settings
3. UPS settings
4. UPS shutdown time setting
5. UPS scheduler settings
6. Message settings
7. Network settings
8. User information update settings

Email Notification

As shown in FIG. 1.13(a), the user can configure the software to send an email message to a plurality of receivers, for example four numbers when an event occurs. To set up email notification for an event, click on settings under e-mail. A configuration page will be displayed. Enter the desired configuration the settings have been saved.

The following is a description of the fields contained on this page:
Enabled select the checkbox to enable sending email notifications for this event.
Email Address(es) The SMTP email address of the recipient. Up to four (4) recipients may be entered in seprate fields. The address must be entered in the default notation (that is recipient@somedomain.net).

SMS Notification

As illustrated in FIG. 1.14, the user can configure the software to send an SMS message at least to four people when an event occurs. To set up SMS notification for an event, click on settings under SMS. A configuration page will be displayed. Enter the desired configuration and select the save button. A message will flash confirming the settings have been saved.

The following is a description of the fields contained on this page:
Enabled select checkbox to enable sending SMS notifications for this event.
Mobile No. Mobile No. of the recipients. At least four (4) recipients may be entered in separate fields.

As shown in FIG. 1.15, a user can facilitate the use of SMS to get notified of status of UPS parameters. User has to enter the same configuration as mentioned above. The software provides the flexibility to user, to select the parameters to be sent.

Data Log

FIG. 1.13(a) provides the log of UPS data like input and output voltage, input and output frequency, output power and output current, battery capacity, load and UPS status at specified time interval. From the log UPS data user can set interval of his choice that 10, 20, 30, 40, 50 and 60 sec.

UPS Setting

As illustrated in FIG. 1.16, the software provides the way to set some UPS parameters (like battery low level, battery high level and UPS output voltage). It provides flexibility in the sense that user can have control on UPS.

The software provides three types of settings:
Battery Low
Battery High
Output Voltage

Each one of setting has some common values:

Default: Default shows the default value of respective parameter inside the system

Present: Present shows value user has changed from the settings.

Last Saved: shows the previous value the user has saved.

Click on save button to save changes.

Data Update Rate

The software as illustrated in FIG. 1.16, further provides the facility to user to update the data rate speed. Data rate speed available in 2 sec, 4 sec, and 10 sec.

Broadcasting Messages

FIG. 1.17 shows how the software can be configured by the user to broadcast a notification message when an event occurs. To avoid sending broadcasts for events that last only a short time, enter a pop up interval time.

To set up broadcasting for an event, click on settings under Broadcasting Messages. A configuration page will be displayed. Enter the desired configuration and selects the Save button. If user wants to save Default messages for the particular event, click on default button to save default settings. A message will flash confirming the settings have been saved.

Client Connection

The user has to check the client connection option in order to enable Client-server communication. Client-Server communication is checked, by default. If, somehow, user unchecked the client connection option, user need not restart the sever.

Update User Information

As illustrated in FIG. 1.18, an user can change his personal information by checking the update user info option. Click on settings box. The User can see his registered Information on the display:
Update the information
Click on update to save the changes, otherwise changes will not save.
Click on exit for not saving the changes made.

Priority Based Settings

The server has full rights to select the time (which is used as display time for priority based shutdown) for each client priority is divided into two categories, Low and High. Whenever the time is selected, Low priority will get selected time and High priority would be double of selected time (if server has elected 30 sec., Low priority would get 30 sec. and high priority would get 60 sec.) to get shutdown. Server has full authority to select and update the priority time. (See FIG. 1.13(a)).

UPS Scheduler Settings

The User can use the Weekly Shutdown Schedule to shutdown all or segments of the UPS load at a certain time each day (for example, from after the close of business to before the start of business the next day). FIG. 1.19 shows the Periods when the system is scheduled to be “on” are shown in orange and Period when the system is scheduled to be “off” are shown in white.

To shut down the UPS at the same time each day of week
Open the UPS scheduler dialog box.
Choose a day from the Weekday field.
Select a shutdown time clicking on Setup button against Shutdown Time.
Click on Save Schedule to save the Settings.

If a user wants to remove schedule for a particular day, click on remove schedule, select the day, press OK button to remove the schedule.

To view the schedule, press the Schedule Log button.

Server Shutdown Settings

Use the mouse to select values from 30, 45, 60 and 90 seconds. This sets the interval between the time the software begins to shut down the windows environment and when the power from the UPS shuts off. (See FIG. 1.13(a)).

View Data Logged File

As shown in FIG. 1.20, a user can view the logged file by File→View Data Log.

A user can view data logged at any time. Data logged are:
Date
Time
Input and Output Voltage
Input and Output Frequency
Output Current
Battery Voltage
UPS status

Refresh Button: Refreshes the data each time one clicks on it. Records are refreshed according to the logged time Interval set by the user.

Erase Button: Delete all the records.

Print Button: Print the logged data.

Connected Users List

The Server lists the client's status, whether they are online or offline, Clients

Name, Priority and their IP Addresses. Connected Users shows the Number of clients online.

View Graphs

Features
Auto and manual saving of graph
Maximum and minimum value at any time
Plotting of data from files.

As illustrated in FIGS. 1.21, 1.22, 1.23, 1.24 and 1.25, the user can view three different types of graphs:
Input and Output voltage
Input and Output Frequency
Output Power

Some of the key terms are defined below:
Present value: Present value is the plotting value, means, value that is plotting on the graph.
Max value: It shows the maximum value in the graph.
Min. Value: It shows the minimum value in the graph.
Graph value: Value which user can see at the bottom right corner by moving the mouse over the graph.
Mode: Graph can be saved in two modes: Auto and Manual. Auto mode saves graph automatically. In manual option, users are allowed to save graph by his own choice that is whenever he wants.
Start Time: Time when the user has started plotting the graph.
End Time: Signifies the end of Plotting of Graph. It helps in identify the total time taken to plot a graph.
Start and Stop: Click on start button to initiate the plotting of the graph.

Click on Stop button to stop the plotting of graph.
Print: Click on Print button to Print the Graph.

Offline Status

The moment, the Application runs, the UPS Parameters would start saving in file. Later on, if users want to see at some point of time, the status of UPS Parameters (like Input and Output Voltage, Frequency and Output Power) user can see and analyze the status as shown in FIG. 1.25(a).

Open: Click Open button to open the specified file.

Next: Click to view the next screen of plotted graph.

Previous: Click Previous to view the previous screen of plotted graph.

Print: Click Print to print the graph.

Save Graph: Click Save Graph to save the graph as picture file.

Graph Options: move up and down through keys to see the graph of (Input & Output Voltage, Frequency and Output Power).

Client Software

User Registration

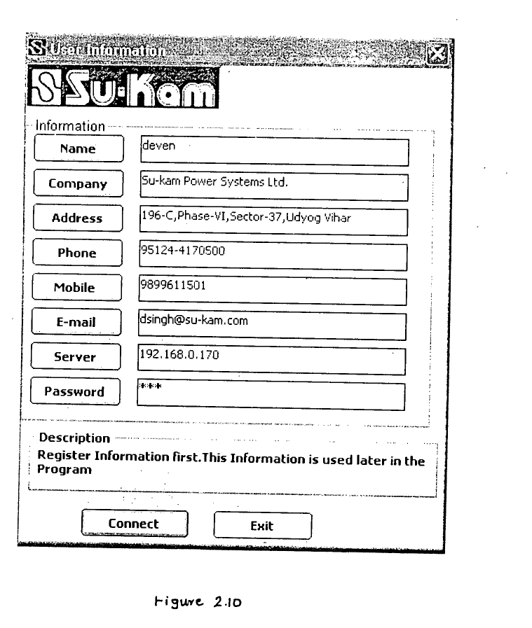

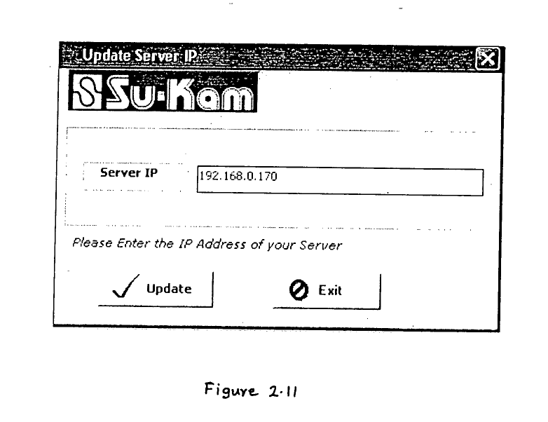

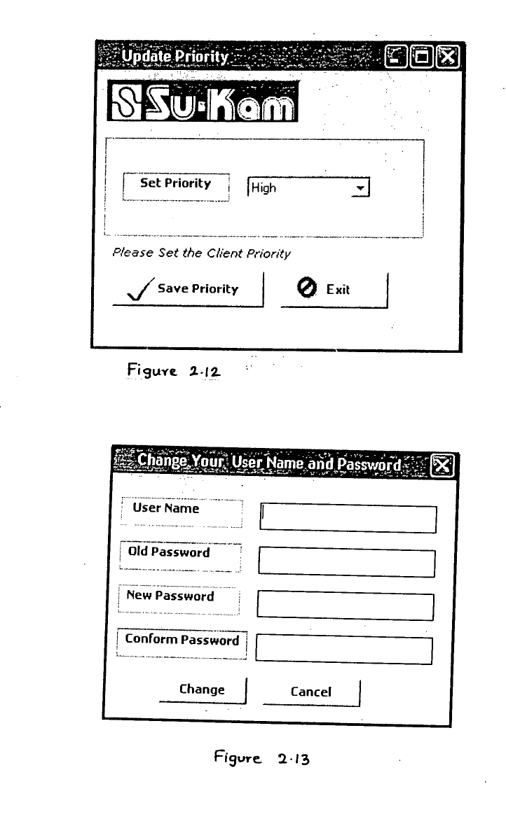

As shown in FIG. 2.10, a user has to register first before running the IntelliQ client software. User account is set up for the software. Logging in under this account allows you to completely configure the software proper information should be filled and no information should be left blank. Server IP Address is IP Address of the machine where Server is installed.

Update Server IP

Client has been given the permission to update the server IP address. Connection gets close as soon as user would change Serever IP. Goto Update→Server IP Address. Change the server IP Address and click update to re-establish the connection with new Server IP Address. (See FIG. 2.11).

Security

Secure Access: The software provides secure access for user to make changes. A user who has a valid account, only, makes changes in the Priority. IntelliQ Client provides secure way to make changes. A user has to enter his valid user name and password in order to access the settings. Click OK to validate the user name and password and make access to Priority.

Update Priority

As illustrated in FIG. 2.12, the Client has, by default, priority “Low”. Priority can be changed from “Low” to “High” and vice versa. Go to Update→Priority Select priority from combo box. After changing the priority, clients have to restart the application in order to make the changes permanent.

Update User Name and Password

As shown in FIG. 2.13, the client can change his user name and password. Type the valid user name, user old password, and new password and then conform new password by retyping it once again. Click change to change User name and Password.

Although the foregoing description of the present invention has been shown and described with reference to a particular embodiment and application thereof, it has been presented for the purpose of illustration and description and is not intended to limit the invention to the particular application as disclosed. It will be apparent to those having ordinary skill in the art that a number of modifications, variations, or alternations to the invention as described herein may be made none of which depart from the spirit or scope of the present invention. The particular embodiment or application has been chosen and described to provide the best illustration of the principles of the invention and its practical application to thereby enable one of ordinary skill in the art to utilize the invention in various embodiments or applications with several modifications to suit the particular use contemplated. All such charges, modifications, variations and alterations should therefore be seen as being within the scope of the present invention as determined by the appended claims when interpreted in accordance with the breadth to which they are fairly, legally and equitably entitled.

1. A monitoring and controlling software embeddable into a DSP based Online UPS system for monitoring and controlling the Online UPS, the software comprising a server application software and a client application software, and configured to
displaying UPS parameters in in digital including graphical form;
logging UPS parameters at specified intervals ranging from 10 seconds to 60 seconds to keep a track of its performance;
providing a unique log in and a password.

2. The monitoring and controlling software as claimed in claim 1, wherein the system is enabled to send an email to Single/Multiple users on different conditions such as ‘battery voltage low’, ‘battery voltage high’, ‘output over voltage’, ‘output under voltage’.

3. The monitoring and controlling software as claimed in claim 1, wherein the system is enabled to generate SMS of UPS parameters regularly at specified intervals from 30 minutes to 3 hours.

4. The Monitoring and controlling software as claimed in claim 1, wherein the system is enabled auto-saving of files on the computer before the shutdown.

5. The monitoring and controlling software as claimed in claim 1, wherein the system provides a flexibility to the end user to toggle off server and UPS shutdown.

6. The monitoring and controlling software as claimed in claim 1, wherein the system providing auto saving of UPS parameters in the files and enabling the end user to view the status of the UPS parameters including printing of graphs and logged data.

7. The monitoring and controlling software as claimed in claim 1, wherein the system is enabled to allow broadcasting of several notification messages like ‘battery voltage low’, ‘battery voltage high’ and overhead messages to client PC's.

8. The monitoring and controlling software as claimed in claim 1, wherein the system, provides audio alert warnings to the users.

9. The monitoring and controlling software as claimed in claim 1, wherein the system is enabled to allow the end user to change the UPS settings, including the administrator being enabled to change the priority settings, and to schedule the server, clients and the UPS shutdown.

10. The monitoring and controlling software as claimed in claim 2, wherein the system is enabled auto-saving of files on the computer before the shutdown.

11. The monitoring and controlling software as claimed in claim 3, wherein the system is enabled auto-saving of files on the computer before the shutdown.

12. The monitoring and controlling software as claimed in claim 2, wherein the system provides a flexibility to the end user to toggle off server and UPS shutdown.

13. The monitoring and controlling software as claimed in claim 3, wherein the system provides a flexibility to the end user to toggle off server and UPS shutdown.

14. The monitoring and controlling software as claimed in claim 4, wherein the system provides a flexibility to the end user to toggle off server and UPS shutdown.

15. The monitoring and controlling software as claimed in claim 2, wherein the system providing auto saving of UPS parameters in the files and enabling the end user to view the status of the UPS parameters including printing of graphs and logged data.

16. The monitoring and controlling software as claimed in claim 3, wherein the system providing auto saving of UPS parameters in the files and enabling the end user to view the status of the UPS parameters including printing of graphs and logged data.

17. The monitoring and controlling software as claimed in claim 4, wherein the system providing auto saving of UPS parameters in the files and enabling the end user to view the status of the UPS parameters including printing of graphs and logged data.

18. The monitoring and controlling software as claimed in claim 5, wherein the system providing auto saving of UPS parameters in the files and enabling the end user to view the status of the UPS parameters including printing of graphs and logged data.

19. The monitoring and controlling software as claimed in claim 2, wherein the system is enabled to allow the end user to change the UPS settings, including the administrator being enabled to change the priority settings, and to schedule the server, clients and the UPS shutdown.

20. The monitoring and controlling software as claimed in claim 3, wherein the system is enabled to allow the end user to change the UPS settings, including the administrator being enabled to change the priority settings, and to schedule the server, clients and the UPS shutdown.
